(19) United States
(12) Patent Application Publication
(10) Pub. No.: US 2020/0195040 A1
(43) Pub. Date: Jun. 18, 2020

(54) UPS Traction Elevator Li-Ion Battery Back-up System

(71) Applicant: New York City Transit Authority, New York, NY (US)

(72) Inventors: Vinod M. Patel, Old Bridge, NJ (US); Ramon Garcia, Freeport, NY (US); John Clark Saling, Maplewood, NJ (US); Henry X. Schober, Trumbull, CT (US)

(73) Assignee: New York City Transit Authority, New York, NY (US)

(21) Appl. No.: 16/712,798

(22) Filed: Dec. 12, 2019

Related U.S. Application Data
(60) Provisional application No. 62/779,472, filed on Dec. 14, 2018.

(51) Int. Cl. H02J 9/06; H02J 7/00; B66B 11/04; B66B 3/00; B66B 5/02

(52) U.S. Cl. CPC H02J 9/062; H02J 7/0042; B66B 5/027; B66B 3/002; B66B 11/0407

(57) ABSTRACT

The uninterruptable battery supply (UPS) traction elevator lithium-ion (Li-ion) battery back-up system provides back-up DC power to a traction elevator when AC power is out. It comprises at least two separate battery systems. The Primary Li-Ion Battery Back-up System includes at least one rechargeable Li-Ion battery and a power interconnection module for sending power from the rechargeable Li-Ion battery to the traction elevator motor when AC power is out. The Secondary Li-Ion Battery Back-Up System includes a UPS and at least one rechargeable Li-Ion battery for powering elevator components and electrical circuits, except for the traction elevator motor, when AC power is out.

### CROSS REFERENCE TO RELATED APPLICATIONS

This application claims the benefit of U.S. Provisional Application No. 62/779,472, to Patel et al., filed Dec. 14, 2018, and entitled “Traction Elevator Battery Back-Up System”, the entire contents of which are incorporated herein by reference.

### STATEMENT REGARDING FEDERALLY SPONSORED RESEARCH OR DEVELOPMENT

This invention was made with government support under pre-grant ID: 1786-2018-5 awarded by the Federal Transit Administration (FTA). The government has certain rights in the invention.

### BACKGROUND OF THE INVENTION

Traction elevators often generate excess energy when they overhaul loads. What happens to this excess energy depends on how far and how fast elevators operate.

Where traction elevators operate at longer distances and/or at higher speeds (e.g., greater than or equal to 500 feet per minute (fpm)), there tends to be a relatively significant amount of excess energy that needs to be dissipated. Current systems generally dissipate this excess in one of two ways. One, for traction elevators operating under normal power, electrical loads on the building's power grid absorb the excess energy and convert it into reusable energy. This conversion may be referred to as regenerative. Two, for traction elevators operating under standby power, electrical loads on standby generators absorb the excess energy. In both cases, additional electrical loads may be necessary for absorption.

Where traction elevators operate at shorter distances and/or at slower speeds (e.g., less than or equal to 350 fpm), there tends to be a relatively small amount of excess energy. Because of this amount, resistor banks are primarily used to dissipate the excess energy as heat. This method of dissipation may be referred to as non-regenerative.

However, a majority of elevator machine rooms (EMRs) for elevators in non-regenerative environments have space constraints or are located underground or both. When traction elevators in these EMRs are replaced with the growing demand for newer, faster traction elevators, operating the latter generates a lot more excess energy. If this excess energy were to be dissipated as heat in the EMRs, the heat generated greatly intensifies. In turn, cooling requirements significantly increase. Without adequate cooling, the traction elevator's operability can be quickly challenged. Worst case scenario is the traction elevator stops running or breaks down due to overheating.

A known cooling solution is having an available power source to dissipate the heat at standby power conditions. Current designs incorporate lead-acid and Nickel Cadmium (Ni-Cad) batteries as a standby or battery back-up system. However, these batteries also need to be cooled via special ventilation because of the amount of electrolytes they use. The relatively confined space in EMRs do not allow for this process. Thus, these batteries quickly get depleted.

Thus, what is needed is a traction elevator battery back-up system that can operate without quickly depleting its electrolytes and that do not require special ventilation. It is also ideal that the traction elevator battery back-up system can regenerate power under normal power conditions when not operating under standby conditions.

### BRIEF SUMMARY OF THE INVENTION

The present invention provides DC power to a traction elevator, by way of lithium-ion (Li-ion) batteries, when AC power is out.

### BRIEF DESCRIPTION OF THE SEVERAL VIEWS OF THE DRAWINGS

FIG. 1 illustrates a line wiring diagram of how the back-up battery system components are interconnected as one example of the claimed invention.

FIG. 2 illustrates a line wiring diagram of how the back-up battery system components are interconnected as another aspect of the claimed invention.

FIG. 3 illustrates a line wiring diagram of how the back-up battery system components are interconnected as yet another aspect of the claimed invention.

FIG. 4 illustrates a line wiring diagram of how the back-up battery system components are interconnected as yet again another aspect of the claimed invention.

### DETAILED DESCRIPTION OF THE INVENTION

A traction elevator generally operates through a traction elevator power drive system. Such system may incorporate a normal power alternating current (AC) drive bus and/or a standby/back-up power direct current (DC) drive bus to energize an AC permanent magnet, traction elevator machine motor (such as a gearless one) with a capacity of approximately 10,000 pounds and at a speed of approximately 400 fpm under normal and standby power conditions. However, when normal power is out, the traction elevator becomes nonoperational unless it can be powered from a back-up power source. This situation presents a major safety concern, especially where one or more elevator passengers would be trapped.

To prevent this situation, the traction elevator may be coupled with the claimed invention, an uninterruptable power supply (UPS) traction elevator Li-ion battery back-up system. When the traction elevator's power drive system detects that normal power is out, Controller 140 sends a signal to the UPS traction elevator battery back-up system to move it from a dormant state to an activated state. Upon activation, the amount of back-up energy (i.e., DC power) to be supplied through a DC drive bus should be sufficient to enable the traction elevator to complete two round trips having a full load per one-way trip and at a speed of up to approximately 75% of its normal operational speed. A round trip comprises a one-way trip up and a one-way trip down. The full load is based on the traction elevator's maximum weight capacity.

A. UPS Traction Elevator Li-ion Battery Back-Up System

The UPS traction elevator Li-ion battery back-up system comprises at least two separate battery systems, where each battery system employs one or more Li-ion batteries. The first battery system may be called Primary Li-Ion Battery Back-up System 100. The second battery system may be called Secondary Li-Ion Battery Back-up System 180, or alternatively UPS System.

The Primary Li-Ion Battery Back-up System 100 is a scalable system that powers the traction elevator motor 330 by providing power from one or more Li-ion batteries when normal power is out. It is not expected that the Primary Li-Ion Battery Back-up System 100 provides power to any other component or electrical circuit that run the traction elevator. Rather, when normal power is out, these other components and electrical circuits may be powered by one or more Li-ion batteries from the Secondary Li-Ion Battery Back-up System 180. Examples of these components for this also scalable system include, but are not limited to, controller circuit boards, machine brake(s), encoders, controller programmable logic controller (PLC), door operators on the elevator car, the push-buttons, indicator lights, etc.

The UPS traction elevator Li-ion battery back-up system may be implemented in geared or gearless traction elevators.

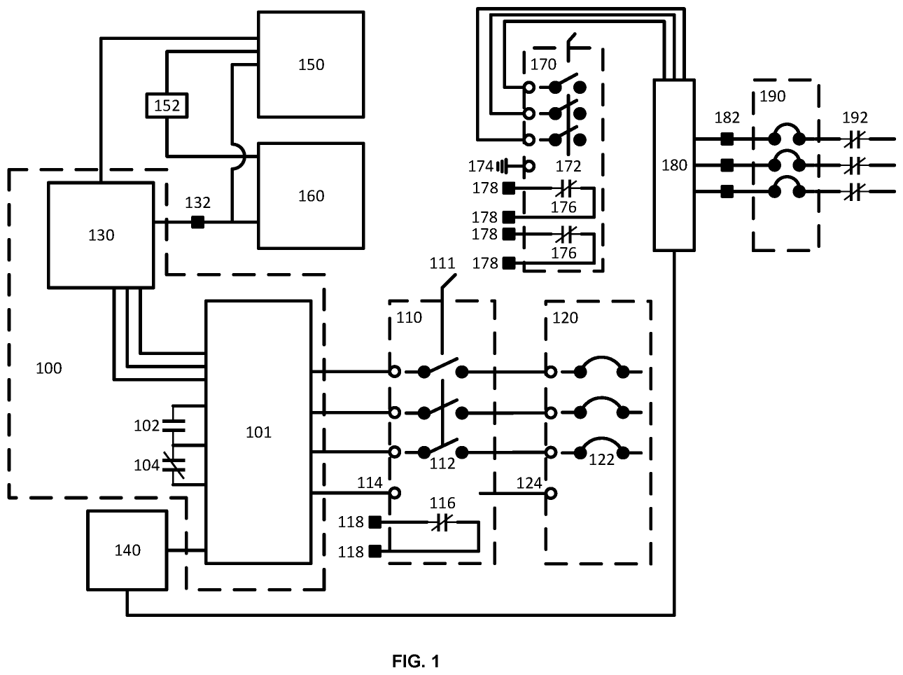

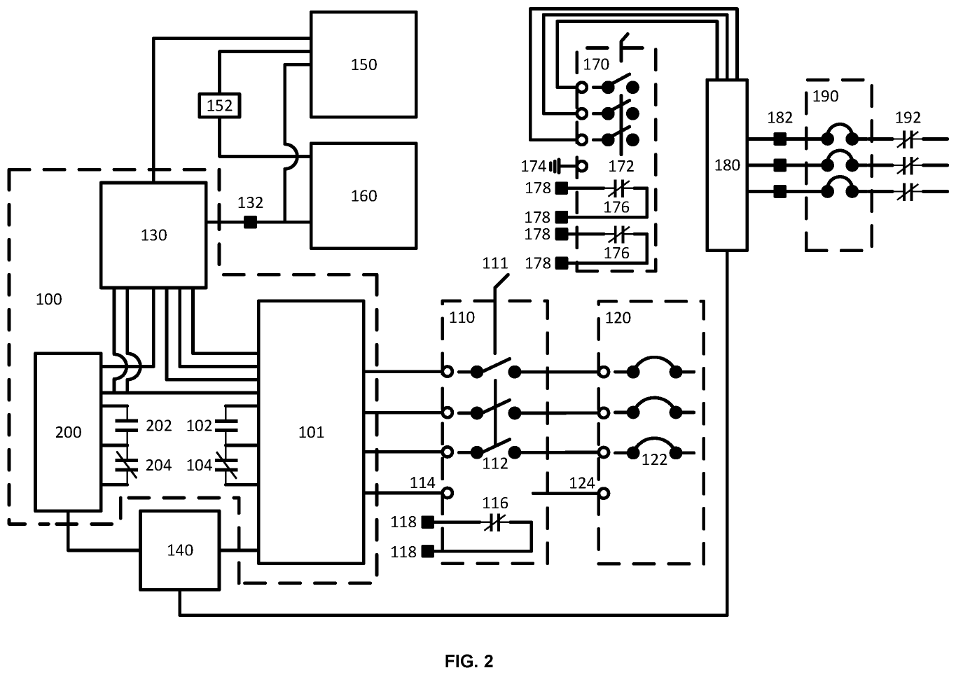

Referring to FIG. 1, the Primary Li-Ion Battery Back-up System 100 for a small traction elevator may comprise one Li-ion battery 101 as its battery power source. An example of a small traction elevator is one having a maximum weight capacity of approximately 2,100-2,500 lbs with an average maximum speed of about 250 fpm. These types of elevators are often geared traction elevators and may be found in low rise buildings. While the claimed invention recognizes only one Li-ion battery 101 may suffice for a small traction elevator, the claimed invention also permits more than one Li-ion battery 101.

Where larger sized traction elevators are demanded or required, the Primary Li-Ion Battery Back-up System 100 may comprise at least two Li-ion batteries 101, 200 as the battery power source, as indicated in FIG. 2. An example of a larger traction elevator is one having a maximum weight load capacity of approximately 3,000-4,000 lbs with an average maximum speed of about 2,000 fpm. These types of elevators may be gearless traction elevators and are often found in medium to high rise buildings.

The main battery, Li-ion battery 101 (e.g., 45 kW, 60 kW, etc.), may serve as the main DC power source for the DC drive bus. One or more additional Li-ion batteries 200 (e.g., 10 kVA) may be added to boost or provide additional power to the DC drive bus. Each of these Li-ion batteries 101, 200 may operate independently of each other.

The Li-ion batteries 101, 200 may be constructed with certain specifications. As an example, the cell chemistry may include lithium, iron, magnesium, and/or phosphate. Cells may be Underwriters Laboratories (UL) 1642 listed. Li-ion batteries 101, 200 may be UL 1973 listed. The nominal voltage may be 24V. The nominal capacity may be 40 Ahr. The maximum continuous charge current may be 120 A. The maximum continuous discharge current may be 320 A. The maximum discharge current (for about 10 secs) may be 700 A. The cell voltage range may be about 2.0V to about 4.2V. The ambient temperature range may be about 10° C. to about 50° C. The operating temperature range may be about −10° C. to 65° C. Li-ion batteries 101, 200 may have active balancing circuitry to balance individual cells or cell packs inside. Li-ion batteries 101, 200 may be able to provide cell or cell pack temperatures, cell pack voltage, and module current. Casing for Li-ion battery 101, 200 should meet UL94-V0 requirements and be constructed to IP56. Li-ion batteries 101, 200 should be certified to transportation specification UN3480, Class 9. The expected battery life should be greater than or equal to 2000 mAH, 100% depth of discharge (DOD), at 1 C rate, 25° C.

Li-ion batteries present certain advantages over other batteries (such as lead-acid batteries, nickel-cadmium (Ni-CAD) batteries, etc.) for UPS systems. Li-ion batteries tend to be smaller in size, lighter in weight, and have better battery management. For instance, they are generally better at managing current charges, voltages, and cell voltage balances. They also tend to have higher charge times, discharge times, and recharge times due to their relatively small amount of electrolytes. More importantly, because Li-ion batteries can operate at higher temperatures, the concern of needing to be cooled while operating in a space-confined and/or underground EMR becomes significantly less of an issue. Thus, Li-ion UPS battery systems can be used to absorb excess energy that is generated from an elevator.

Other batteries (such as lead-acid batteries) have failed and are disadvantageous for elevators in EMRs with confined spaces and/or in underground EMRs because they are known to have higher levels of electrolytes and require more maintenance that Li-ion batteries. For example, valve regulated lead acid (VRLA) batteries are known to build gas pressure that needs to be released when it reaches a certain threshold. Additionally, since water cannot be added to VRLA batteries, they tend to have a short battery life due to heat and ambient temperature from being charged.

For wet cell batteries, these lead acid batteries are chemically hazardous due to their thick, lead-based plates being flooded with electrolyte acid. They also have more maintenance requirements. They also often require additional water to maintain electrolyte equalization. These two factors weigh heavily against being used in EMRs. First, because of their potential chemical hazards, they often require a separate storage space to curtail environmental concerns. With EMRs already being space challenged, there often isn't any room to store wet cells. Second, EMRs tend to have very confined spaces or be placed underground. In such cases, finding ways to pour additional water into the wet cells becomes very problematic.

Ni-CAD batteries are also disadvantageous for elevators having EMRs that are space-confined and/or underground. Although they are less expensive, they cannot retain a full charge over time or be recharged often. They are also heavy, bulky, and deteriorate over time. By not holding a charge long or often enough, Ni-CAD batteries are unreliable for use in a traction elevator battery back-up system. For example, if there is a passenger with a medical emergency and is stuck in a traction elevator with a Ni-CAD UPS battery back-up system, the passenger is at a greater risk if the Ni-CAD UPS battery back-up system would fail due to not being fully charged. Furthermore, the weight and size make Ni-CAD UPS battery back-up systems unfavorable for such EMRs.

The Primary Li-Ion Battery Back-up System 100 may also comprise many other components. These include at least one battery enclosure, a battery protection device (such as a breaker, contactor, and/or fuse, whether each is a cabling and/or busbar), and a battery management system. The Primary Li-Ion Battery Back-up System 100 may be UL 1778 and UL 1973 listed. It may be required to work with existing UPS charger(s) and be able to float charge(s) between about 545V and about 580V. The maximum voltage for Li-ion batteries 101, 200 may be greater than or equal to 575V. The minimum voltage for the Li-ion batteries 101, 200 may be less than or equal to 400V. It should be able to handle a 1-minute discharge at about 250 kW.

The battery enclosure needs to be large enough to hold one or more LI-ion batteries 101, 200. As an example of its dimensions, the maximum battery enclosure is twenty-four (24) inches in width, thirty-five (35) inches in depth, and eighty (80) inches in height. The battery enclosure may be of heavy duty construction and a NEMA 12 classification. It may be a powder coated finish or be of a color that matches that of the Li-ion batteries 101, 200. It may further be constructed to meet seismic requirements of certain installation locations. Preferably, for easier access, the battery enclosure would have front access for installation, service, and maintenance. However, entry access for the enclosure may be on the side, top, or bottom.

Also, it is preferable that each battery enclosure provides adequate wire bending space for the maximum number of incoming and outgoing conductors in accordance with the National Electrical Code's (NEC) minimum bend radius for cables. The incoming conductor quantity and size will likely depend on the size (kVA) rating of the UPS. Internal power wiring to each enclosure may be factory provided.

In addition, it is preferable that each battery enclosure features a DC-rated circuit breaker that can protect one or more battery strings within the battery enclosure. The circuit breaker in each battery enclosure may feature an AB auxiliary switch and a undervoltage release (UVR) or a shunt trip. Furthermore, it is preferable that each battery enclosure be capable of being monitored by the LI-ion UPS battery back-up system and sounding an alarm with the circuit is open.

Moreover, it is preferable that each battery enclosure provides adequate ventilation in the front and rear of the enclosure to allow heat to escape. Adequate ventilation may be determined to be the maximum temperature differential between the lowest shelf and upper most shelf of 5° C.

The UPS traction elevator Li-ion battery back-up system and traction elevator components (i.e., Controller 140, AC drive 150, step-up transformer 420, etc.) are very temperature-sensitive. Thus, a thermal management system needs to be in place. While such equipment may operate in a temperature range of up to about 40 degrees Celsius or 104 degrees Fahrenheit, it is preferable to not have the temperature exceed 85 degrees Fahrenheit during normal operations. An exemplified temperature range is between about 55 degrees Fahrenheit and 85 degrees Fahrenheit. Keeping the temperature within this range permits components like the Controller 140 to be rated as such for continuous operations.

Where temperatures are kept at or below 85 degrees Fahrenheit, the claimed invention may regenerate the excess energy under normal power through a regenerative module 160 (Regen module). Where temperatures are above 85 degrees Fahrenheit, the claimed invention may dissipate the excess energy as heat rather than undergo regeneration. Additionally, it is not anticipated that regeneration would take place under standby power.

In addition to temperature, other areas of concern include waveform output, energy transfer time, and PLC requirements. Another is where these components are to be housed.

The Li-ion batteries 101, 200 of the Primary Li-Ion Battery Back-up System 100 and the above components may be housed in one or more cabinets. The cabinet may be placed on top of the traction elevator or sufficiently nearby to enable operation without impedance.

For instance, a Li-ion battery cabinet with Linux Multimedia Studio (LMMS) may be used. Where two or more Li-ion batteries 101, 200 are used, they may be placed in the same cabinet or a separate one. Dimensions of this cabinet may be dependent on the size and dimensions of the traction elevator. For example, the cabinet may be thirty (30) inches in width, thirty-four (34) inches in depth, and sixty (60) inches in height. Another example of cabinet dimensions may be thirty (30) inches in width, thirty-five (35) inches in depth, and eighty (80) inches in height. To meet regulatory clearances (such as those by the NEC), the cabinet must have at least forty-two (42) inches clearance in the front and at least four (4) inches in the rear for air circulation. It does not have to have any clearance on its sides. The Li-ion battery cabinet with LMMS may be located up to about fifty (50) feet of wiring distance from a traction elevator drive cabinet. To manage the temperature, a blower, powered by at least 120VAC, may be used. An example of the blower is one that blows at 1200 cubic feet per minute (CPM).

As an example, the Primary Li-Ion Battery Back-up System 100 may have an electrical size of about 45 kW. It may have a nominal voltage of about 512 VDC, which is approximately 88 A.

Li-ion batteries 101, 200 are preferably rechargeable batteries. Li-ion battery 101 may include or be coupled to a battery charger, such as a TS Series IV battery charger, for self-charging as power in the Li-ion batteries 101, 200 deplete.

Where a battery charger is present, Li-ion batteries 101, 200 may be housed in a Li-ion battery charger cabinet. Examples of dimensions of the Li-ion battery charger cabinet may be the same as that of the Li-ion battery cabinet with LMMS. However, the former may also house a separate circuit breaker to power the battery charger. An example of a circuit breaker is 20 A 120 VAC. Additionally, a different blower, such as an eight hundred (800) CFM blower, may be used as a thermal management system.

In another embodiment, the battery charger may be housed in the Li-ion battery cabinet with LMMS.

Alternatively, Li-ion battery 101 may be recharged from a battery charger supply (such as a trickle charger) 120 via a UPS Disconnect 110, so long as switches 122 remain closed. The battery charger supply 120 may be connected to, and be powered by, the main electrical supply 111, which may be 208 VAC, 3 phase, 60 Hz. Not only may the battery charger supply 120 recharge one or more Li-ion batteries 101, 200, but it may also be used to maintain battery life of each Li-ion battery 101, 200.

The main electrical supply 111 may also power the UPS Disconnect 110. Examples of UPS Disconnects include, but are not limited to, 30 A 240V 3-pole 3-phase nonfusable, 60 A 240V 2-pole fused outdoor, and 100 A 240V 2-pole fused indoor. The UPS Disconnect 110 may include switches 112, a ground 114 for safety measures, a contactor 116, and dry contacts 118. These dry contacts 118 may be used to communicate to Controller 140 as to, for example, when it is time for maintenance, battery life status, etc.

Each Li-ion battery 101, 200 may include contactors 102, 104, 202, 204. Such contactors may be used as signal dialogs for cross-checking and/or determining whether it is safe for their respective batteries 101, 200 to operate.

When normal power is engaged, Li-ion battery 101 (and others, e.g., 200, if present) remains inactive. In essence, it is in a standby mode (i.e., back-up power).

In the event of a loss of normal power while the traction elevator is moving, the elevator may come to a stop for a brief period (such as about 3 to about 5 seconds). During this time, Controller 140 verifies that all present Li-ion batteries 101, 200 (including any additional ones) are engaged and powered-up with sufficient power to enable the traction elevator to complete two round trips.

The elevator may then be permitted to descend via gravity to the next landing and permit its doors to be open. In such case, branch feeders and the elevator mainline feeder may communicate with the elevator controls to distinguish the difference between a loss of normal power to feeders, and the intentional opening of an electrical switch to perform maintenance.

As an embodiment, the UPS traction elevator battery back-up system serves as a sophisticated two-tiered monitoring and safety system.

In the first tier, Li-ion batteries 101, 200 may operate as a true UPS by directly communicating crucial information to Controller 140 via at least one mechanical contactors and/or signal dialogs. Information may include, but not be limited to: (1) Low Battery Condition; (2) Loss of Normal Power; (3) Ready to Run; (4) Phase loss; and (5) Battery Over-temperature Warning.

The second tier may involve a software based Transmission Control Protocol/Internet protocol (TCP/IP), such as Modbus Protocol or its equivalent, or software-defined networking (such as OpenFlow). Either may enable the UPS traction elevator battery back-up system to communicate, with Controller 140 and with the elevator monitoring system, data to diagnose the status of the system(s) and management/maintenance requirements. Nonlimiting examples of this data include: (1) overcharge warning, alarm, and protection; (2) over discharge warning, alarm, and protection; (3) over temperature warning, alarm, and protection; (4) over current warning, alarm, and protection; (5) control of balancing with in each module and across all modules; (6) warning, alarm, and protection for other conditions, such as loss of communication, incorrect configuration, etc.; (7) system voltage; (8) system current; (9) individual module voltages; (10) individual module currents; and (11) individual module temperatures. After a diagnosis, the elevator monitoring system may report its findings to a communications control center.

The Li-ion batteries 101, 200 of the Primary Li-Ion Battery Back-up System 100 are not expected to power Controller 140. Their purpose is to provide backup power to the traction elevator motor 330 as the traction elevator transitions from operating under normal power (AC power) to operating under standby/back-up power (DC power) when natural power is out. Natural power is the AC power the comes from main power supply 111. Where Li-ion batteries 101, 200 are sufficiently charge, the transition may occur without any interruption.

To power the Controller 140 (and thus enable it to continue monitoring power systems), as well as other components and/or electric circuits of the traction elevator, when normal power is out, a Secondary Li-Ion Battery Back-up System 180 may be used. Nonlimiting examples of these components and electric circuits include door operations, fixtures, machine brake circuits, safety chain circuits, car lights and fans, auxiliary circuits, controller PLC, encoders, controller circuit boards, and other electrical and mechanical components.

The Secondary Li-Ion Battery Back-up System 180 comprises a UPS and at least one Li-ion battery 180. The UPS may support a load of 5kVA. However, the UPS may be scaled and sized according to a user's preference or requirements. For instance, where a 3-phase power supply is available at 208 VAC, the UPS may be sized to 10 kVA. Its outputs may vary as well, such as from 3 A to 6 A at 120 VAC single phase and 230 VAC single phase.

As for one or more Li-ion batteries in the Secondary Li-Ion Battery Back-up System 180, it may be the same as that of the Primary Li-Ion Battery Back-up System 100 or hold a higher or lower charge. In essence, these Li-ion batteries may be 45KW, 60 kW, etc. They are preferably rechargeable batteries. They may also include or be coupled to a battery charger, such as a TS Series IV battery charger.

Alternatively, these Li-ion batteries may be recharged from the main electrical supply 111 via a UPS Disconnect 170, so long as switches 172 remain closed. Examples of UPS Disconnects include, but are not limited to, 30 A 240V 3-pole 3-phase nonfusable, 60 A 240V 2-pole fused outdoor, and 100 A 240V 2-pole fused indoor. The UPS Disconnect 170 may include switches 172, a ground 174 for safety measures, contactors 176, and dry contacts 178. These dry contacts 178 may be used to communicate the operational status of the UPS and the battery life and maintenance status of the Li-ion batteries.

The Secondary Li-Ion Battery Back-Up System 180 may be connected to the controller main breaker 190 via dry contacts 182. The dry contacts 182 may be used to identify whether, for example, electricity is flowing from the battery to the controller main breaker 192 so as to prevent the main breaker from kicking off one or more electric circuits when the main power is out and the standby power is running. Power may flow from there through line contactors 192 to the traction elevator control section(s).

Like the Primary Li-Ion Battery Back-up System 100, the Secondary Li-Ion Battery Back-up System 180 may also comprise many other components. These include at least one battery enclosure, a battery protection device (such as a breaker, contactor, and/or fuse, whether each is a cabling and/or busbar), and a battery management system. The Li-ion batteries for the Secondary Li-Ion Battery Back-up System 180 may be UL 1778 and UL 1973 listed. It may be required to work with the UPS charger of the Secondary Li-Ion Battery Back-up System 180 and be able to float charge(s) between about 545V and about 580V. The maximum voltage for Li-ion batteries may be greater than or equal to 575V. The minimum voltage for the Li-ion batteries may be less than or equal to 400V. It should be able to handle a 1-minute discharge at about 250 kW.

The Secondary Li-Ion Battery Back-Up System 180 may comprise of two cabinets—one for the UPS and one for the at least one Li-ion battery. Dimensions of these cabinets are dependent on the sizes of the UPS and the at least one Li-ion battery. The UPS cabinet may be twenty (20) inches in width, twenty-seven (27) inches in depth, and fifty-five (55) inches in height. The Li-ion battery cabinet may be twenty-four (24) inches in width, thirty-three (33) inches in depth, and forty-three (43) inches in height. Alternatively, the UPS and at least one Li-ion battery may be of the same cabinet having a dimension of, for example, twenty (20) inches in width, twenty-seven (27) inches in depth, and fifty-six (56) inches in height. Whichever each cabinet's size is, to meet regulatory clearances (such as those by the NEC), the cabinet must have at least forty-two (42) inches clearance in the front and at least two (2) inches at the sides and in the rear for air circulation. The cabinet containing one or more Li-ion batteries may incorporate a blower, such as a 1200 CFM blower powered by at least 120 VAC, to manage the temperature.

Controller 140 may provide an audible and/or visual indication as an alert or emergency status during normal power and when Li-ion batteries 101, 200 are engaged or operating in place.

When operating on battery power, the traction elevator's movement becomes dependent upon the battery's energy level. To determine if the Li-ion batteries 101, 200 are insufficiently charged to run the elevator safely, Controller 140 may be wired to the battery management system and be programmed to trigger a signal when battery life of any Li-ion battery 101, 200 is low, drained, or falls below a certain threshold (e.g., 25% charged). Such signaling enables a user to determine whether it is safe or unsafe to run the elevator on battery power. Signaling may also be triggered for any other condition that may require the elevator to cease operation in advance of a battery system failure.

Controller 140 may be designed to supervise the traction elevator's controls. To operate the traction elevator and monitor its operations, Controller 140 may be designed to use, or incorporate for use, a PLC. The PLC may use optically isolated input/output (I/O) points. As an embodiment, the PLC and all of its components may be rated at 0-50° C. (or 32-122° F.). As another embodiment, the PLC and all of its components may be rated at about 85% humidity.

The PLC may provide spare inputs and/or spare outputs. In one embodiment, the PLC may have at least 6 spare inputs. In another embodiment, the PLC may have at least 6 spare outputs. Each input and output shall have a status lamp to indicate “change of state”. Each of the PLC power supplies and I/O circuits should provide surge protection in accordance with Institute of Electrical and Electronics Engineers (IEEE) 472.

The PLC may also incorporate one or more of the following features: (1) user program protection; (2) at least one dedicated communication port configured for remote monitoring interface RS485 and/or Ethernet; (3) the ability to communicate with any of the following: Modbus RTU or TCP/IP; Ethernet IP; DeviceNet; Profibus; ProfiNet; or a memory card (e.g., SD Card, compact flash, USB flash drive port, etc.) that can reprogram an existing or new PLC processor, perform any necessary firmware upgrade, and download/upload data files as necessary without the need for a laptop; (4) memory that may reprogram an existing or new PLC processor, perform any firmware upgrade, and download or upload data files without the assistance of a laptop; and (5) an industrial flat touch screen monitor.

The touch screen should be of sufficient size to display information and allow for interaction. For example, the touch screen may be measured at at least 7 inches diagonally. The monitor may also be a thin-film-transistor liquid crystal display (TFT LCD) with a resolution of 800×400 or better.

Information shown on the touch screen display are programmable. Nonlimiting examples of information include operating mode (automatic, independent, continuous operation test mode, Fireman's Phase I, Fireman's Phase II, top-of-car inspection, in-car inspection, controller inspection, etc.); date and time; and total number of trips made while in automatic, independent, and continuous test modes (trip is from door close to door open). Where the elevator is not operational, an activated safety device or other fault responsible for the shutdown may be displayed. Where more than one device or fault is activated, the last activation may be displayed.

The PLC may also permit separate “event history” and “fault history” screens to be displayed. For purposes of “event history”, an event is a change of state of the elevator, including, but not limited to, remote car and hall calls, changes of operating mode, changes of the state of other switches (e.g., hoistway door bypass, door open limit, door close limit, etc.), and the activation and deactivation of safety devices. For purposes of “fault history”, the fault history screen shall list devices and any other faults which prevent the elevator from operating (e.g., pit switch activated, etc.) that occur in automatic, independent, or continuous operation mode. Both the event history screen and fault history screen may be configured to store at least the last 200 entries, whether it be an event or a fault, with each entry having a date and time stamp.

The PLC may also display addition screens. For instance, a separate screen may be displayed to access all user-adjustable settings. In addition, a “usage screen” may also be displayed to show the number of trips over a set period of time (e.g., the last 24 hours, last 7 days, last 30 days, etc.). The usage screen may also display the average number of trips per said set period of time that the elevator has made while operating in a particular operating mode (e.g., automatic operation mode, independent operation mode, continuous operation mode, etc.).

The PLC may incorporate one or more different types of read-only memory (ROM). Example include, but are not limited to, erasable programmable ROM (EPROM); electrically erasable programmable ROM (EEPROM); and flash EPROM. As a preferred embodiment, the PLC incorporates flash ERPOM, which generally requires no battery back-up system to store a program, settings, events, and/or faults.

As for switches, Controller 140 may incorporate one or more of the following: controller stop switch; hall call disconnect; controller inspection; car door bypass; and hatch door bypass. Controller 140 may also include pushbutton inputs, such as controller inspection up and controller inspection down. Furthermore, Controller 140 may incorporate control equipment, including but not limited to: PLC, all relays (including illuminated-type relays), and all printed circuit boards.

The Controller 140 and its incorporated components may be housed in a controller cabinet. An example of the controller cabinet's dimensions is thirty-six (36) inches in width, sixteen (16) inches in depth, and seventy-two (72) inches in height. To meet the NEC, the controller cabinet must have at least forty-two (42) inches clearance in the front and at least two (2) inches at the sides and in the rear for air circulation. It does not have to have any clearance on its sides. Such cabinet may be located adjacent to the traction elevator motor. As another example, it may be NEMA 12 and may have a hinged door and a handle.

Controller 140 may include a work light, which may be LED, that may automatically operate when the Controller door is open. Controller 140 may also include a convenience duplex receptacle. These devices may be powered by the power supply 111, 120 for the Out of Service Light, when one is provided. Otherwise, the devices may be powered by an independent branch circuit.

Alternatively, instead of illuminating an “Out of Service” sign, the touch screen of Controller 140 may display an “OUT OF SERVICE” message whenever the elevator is not available for passenger use or when the claimed invention is in use. Other instances where the message is indicated include: when the elevator is in any operation mode other than automatic; when any safety device has tripped; when the elevator has lost power; or when the door interlocks prevent the elevator from operating.

Where Controller 140 may be connected to one or more power sources, one or more warning signs should be in place. For example, the controller cabinet may post an exterior and interior warning sign stating “WARNING—MULTIPLE POWER SOURCES.”

Controller 140 may further include a reset button. If so, the reset button may be used to clear latched faults (i.e., low oil timer). The reset button may have an integral light (such as an LED light) that may illuminate (such as red) when a latched fault is active and a reset is required. The light on the reset button may be extinguished when the button is pressed and the fault is cleared. In addition, when a latched fault occurs, the touch screen display may display a message stating that the reset button must be pressed.

Where there is a traction elevator status transmitter, Controller 140 may connect to it via a single serial connection. The traction elevator status transmitter may be a monitoring system that wirelessly transmits or communicates the status of an elevator to a central monitoring system. Data communicated may include faults log, events log, warnings, and alarms.

Where multiple Controllers are introduced, each Controller may be provided with a relay test panel inside the Controller to test all plug-in relays. The relay test panel may have the following features: a light to check all normally open and normally closed contact; a voltage selector switch for AC and/or DC coils; test buttons or switches; and a relay reference table.

The Primary Li-Ion Battery Back-up System 100 may further include a power interconnection module 130. This module may serve as a terminal block for receiving power via electrical wires from one or more Li-ion batteries 101, 200. In turn, power interconnection 130 may take power from one or more Li-ion batteries 101, 200 and run it through the traction elevator motor 330. Having a power interconnection 130 may prove useful and advantageous given the size of wires being run into the AC drive 170 and Regen module 180.

Connected to the power interconnection module 130 may be a fuse monitor contact. Such contact may help indicate whether a fuse is blown and can help explain when a circuit is determined to be open.

An optional battery 132 may be put in place as a power source for the power interconnection 130, AC drive 150, and/or Regen module 160. If in existence, the battery 132 shall have sufficient voltage to supply power to the power interconnection 130, AC drive 150, and/or Regen module 160 if power is out or a fuse is blown.

It is preferable that a drive protection circuit is provided between the power interconnection module 130 and AC drive 150. Also, it is preferable that the drive protection circuit be suitably sized to protect the elevator drive from any power surges that may emanate from the Primary Li-Ion Battery Back-up System 100. Additionally, it is preferable that the Primary Li-Ion Battery Back-up System 100 be configured so that it can be used with a shunt-trip breaker, diodes, and fuses, as needed.

The Primary Li-Ion Battery Back-up System 100 and Secondary Li-Ion Battery Back-Up System 180 may independently report battery monitoring and management from its lithium battery management system (LBMS) via a software based TCP/IP to one or more real-time monitoring systems. The highest level monitoring system may be a centralized monitoring system that collects and monitors data from one or more geographical regions.

The LBMS may comprise one or more of the following features: overcharge warning, alarm, and protection; over discharge warning, alarm, and protection; over temperature warning, alarm, and protection; over current warning, alarm, and protection; control of balancing with in each module and across all modules; and warning, alarm, and protection for other conditions, such as loss of communication, incorrect configuration, etc.

The LBMS may also comprise a fail-safe mode to disengage one or more battery strings if LBMS is damaged, malfunctioning, or loses power.

Furthermore, the LBMS may provide or display one or more types of information. Nonlimiting examples include system voltage; system current; state of charge; individual module voltages; individual module currents; individual module temperatures of cell packs (minimum 6 points/probes/sensors); and individual module temperatures of at least one printed circuit board assembly (PCBA) (minimum 3 points/probes/sensors). Each point/probe/sensor may be used to close the loop on its performance and/or status to itself. The LBMS may also include local data access and be capable of providing said data via TCP/IP or equivalent to higher level system.

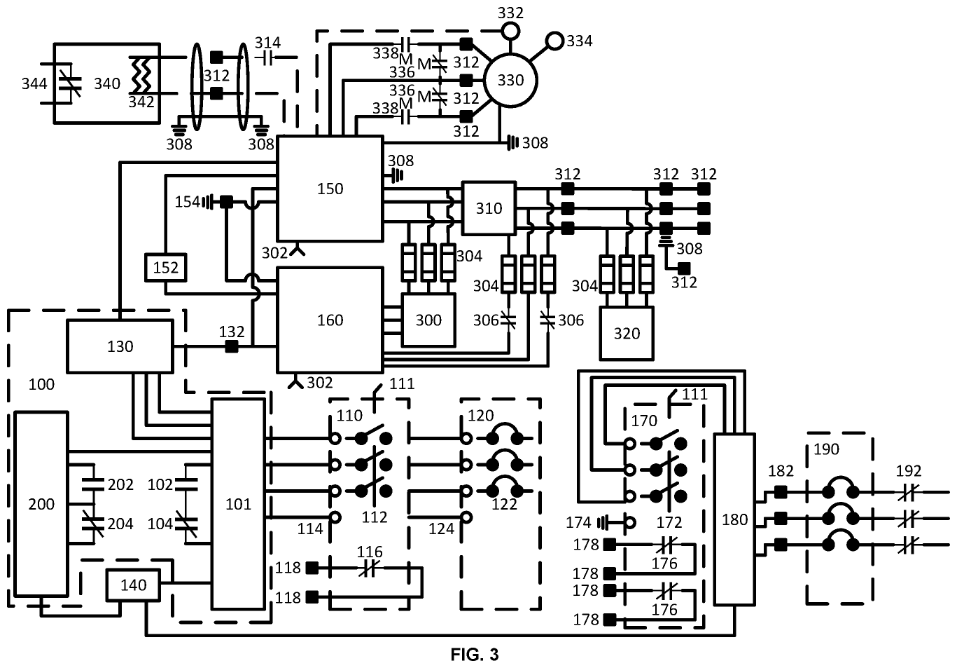

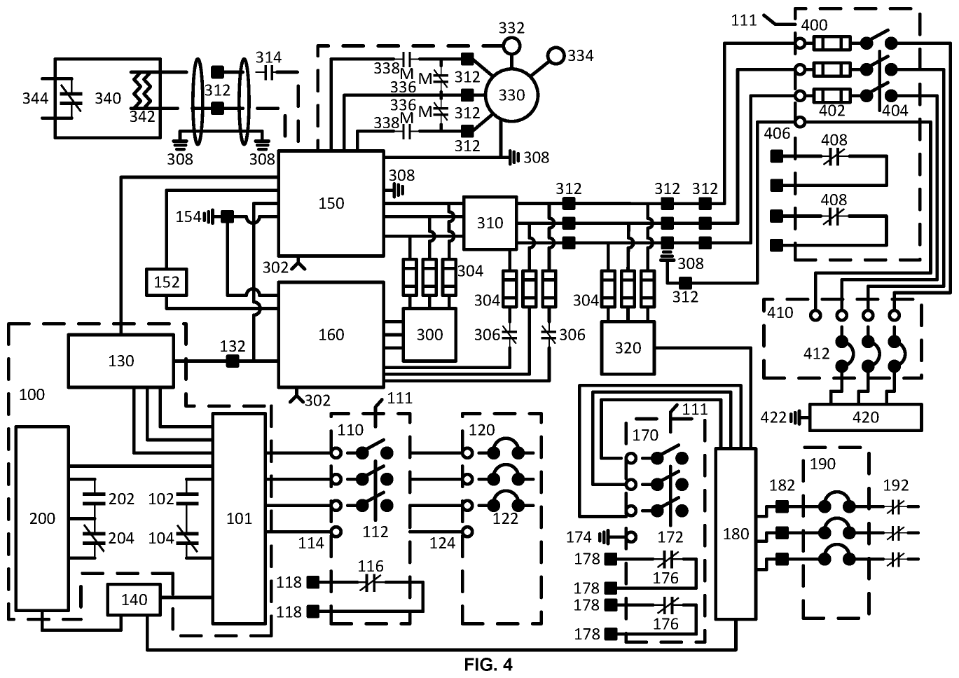

Referring to FIG. 3 and FIG. 4, AC drive 150 serves as the module that supplies normal power to a traction elevator machine motor 330. Normal power generally refers to power that comes from the main electrical supply 111. The traction elevator machine motor 330 may be geared or gearless.

The AC drive 150 takes commands from Controller 140 to determine how hard it must work (such as how much power to supply to accelerate or decelerate the traction elevator machine motor 330). To enable communication between AC drive 150 and Controller 140, there is a PLC serial connection 302 between these two modules. Examples of communicated data include, but are not limited to, states of voltages, states of faults, etc. The PLC serial connection 302 may also be used to determine where an encountered problem may exist and how to troubleshoot.

The AC drive 150 may be housed in an elevator drive cabinet. An example of the dimensions of the elevator drive cabinet may be sixty (60) inches in width, twelve (12) inches in depth, and eighty-four (84) inches in height. To meet regulatory clearances (such as those by the NEC), the elevator drive cabinet must have at least forty-two (42) inches clearance in the front and at least two (2) inches at the sides and in the rear for air circulation. It may be placed at adjacent to Controller 140.

Connections between the AC drive 150 and the traction elevator machine motor 330 include motor contactors 336, 338. Motor contactors 336, 338 enable current to be switched and protect the traction elevator machine motor 330 from overcurrent damage. To detect whether there is electricity flowing through any of the motor contactors 336, 338 (i.e., open or closed switch), dry contacts 312 may be put in place.

The traction elevator machine motor 330 includes a manual brake release 334. This release 334 permits one to check whether the elevator brake system (e.g., brake disc, plunger rod, brake lever, nuts, bolts, etc.) is operating or functioning properly.

Several safety and protection measures may be placed throughout. To protect against electrical shock, ground wiring 308 is incorporated throughout the traction elevator. To prevent AC drive 150 and/or Regen module 160 from overheating, a heat sink 152 may be incorporated. The AC drive 150 may be connected, via at least connector 314 and at least one dry contact 312, to an external braking resistor bank 340. This module 340 serves to channel energy in an emergency and dissipates energy as heat if the traction elevator or AC drive 150 overheats. The external braking resistor bank 340 may include one or more attenuators 342 to lower voltage and/or dissipate power or energy. It 340 may also include an overheat thermostat 344 to monitor the temperature of the circuits. As another heat module detector, a shunt trip may be incorporated. The shunt trip serves as a breaker to open the circuitry when it detects the traction elevator, the traction elevator machine motor 330, and/or AC drive 150 is getting too hot, and if so, shuts off the flow of electricity.

An example of the dimensions of the resistor bank 340 may be forty (40) inches in width, twenty-two (22) inches in depth, and forty-four (44) inches in height. To meet regulatory clearances (such as those by the NEC), the resistor bank 340 must have at least forty-two (42) inches clearance in the front and at least twelve (12) inches at the sides for air circulation. It may be placed at about fifty (50) feet or less wiring distance from the elevator drive cabinet. It may also be wall-mounted.

A Regen module 160 is incorporated and may be connected to the AC drive 150 and power interconnection module 130. The Regen module 160 absorbs excessive energy that may emanate from the traction elevator machine motor 330 when the traction elevator decelerates or comes to a stop. Such absorption reduces heat and helps keep the ambient temperature under 85 degrees Celsius.

Similar to the AC drive 150, the Regen module 160 may communicate with Controller 140 by way of a PLC serial connection 302. An example of communicated data is the amount of energy stored.

Excess energy, whether or not absorbed by the Regen module 160 and whether or not emanating from AC drive 150, may flow to a power coordinating reactor 310. The power coordinating reactor 310 is a module that serves as a safety precaution by taking excess energy and putting it back into the main electrical system 111. It 310 also serves as a mechanism to prevent one or more fuses from blowing.

A line reactor module 300 may also be incorporated. This module 300 serves as an electric current suppressor to move current out of the Regen module 160. As a precautionary measure, one or more resistors 304 may be put in place for current to travel from the Regen module 160 to the power coordinating reactor 310. Advantages of having a line reactor module 300 include assisting in directing how power is disseminated and preventing one or more fuses from blowing.

Alternatively, excess current may also flow from the Regen module 160 via synchronized lines, through one or more resistors 304, directly to the power coordinating reactor 310.

Excess current may flow from the Regen module 160 via one or more resistors 304 and/or power coordinating reactor 310, through one or more dry contacts 312 and one or more resistors 304, to a Main Switch Disconnect (3-phase) 400 for breaking the current and/or to a ground 308.

The main electrical supply 111 and/or Supply 410 may provide electricity through the Main Switch Disconnect 400 to the AC drive 150. Generally, for a traction elevator, about 460V of electricity may be required. If there is not sufficient voltage (for example, the voltage being supplied by Supply 410 is 208V, 3-phase), a step-up transformer 420 can be used to automatically supplement the voltage to ensure adequate voltage is being supplied. As a precautionary measure, a ground 422 is attached to the step-up transformer 420.

So long as switches 404 in the Main Switch Disconnect 400 remain closed, electricity may continue to flow through the resistors 402 of the Main Switch Disconnect 400 and past thee dry contracts 312 to the power coordinating reactor 310 and then ultimately the AC drive 150.

When the Main Switch Disconnect 400 is off, there should be a signal, alert status, or some other kind of indication for situations where wiring and components inside Controller 140 are not disconnected.

Powering the Controller 140 may be achieved by having electricity flow from the main electrical supply 111 and/or Supply 410 through the Main Switch Disconnect 400 and then through contactors 408 and dry contacts 409 to the Controller 140.

The step-up transformer 420 may have a multitude of characteristics. Nonlimiting examples are as follows. The step-up transformer 420 may be a dry-type transformer. The nominal frequency rating may be 60 Hertz plus or minus 3 Hertz. Each transformer should be UL listed and labeled (such as non-ventilated or ventilated, dry type, continuous duty rated with separate primary and secondary, isolated windings, etc.). Where any single-phase transformers are used, each one should be rated by the manufacturer for operation with the secondary solidly grounded. Three phase transformers may be configured with a delta primary, may be a 4-wire wye connected secondary, and may be rated by the manufacturer for operation with the secondary neutral solidly grounded. The secondary taps may be at 2.5% and 5% full capacity above and below normal voltage. The temperature rise of the windings should not exceed 80° C. in a 40° C. ambient environment. All insulating materials should meet NEMA ST20 standards for a 220° C., UL component recognized insulation system. The transformer coils may be of continuous, wound, copper construction and may be impregnated with non-hygroscopic, thermosetting varnish. Each transformer's core may be constructed of high grade, non-aligning silicon steel with high magnetic permeability, and low hysteresis and eddy current losses. The full load efficiency should not be less than 98%. Magnetic flux densities should be kept well below the saturation point. The core and coil assembly shall then be bolted to the base of the enclosure but isolated there from by means of rubber and vibration-absorbing mounts. There should not be any metal-to-metal contact between the core and coil assembly to the enclosure. Sound isolating systems requiring the complete removal of all fastening devices should not be acceptable. The transformers should be placed in a heavy gauge, sheet steel, totally enclosed, non-ventilated or ventilated, floor mounted enclosure. All of the transformer enclosures shall be degreased, cleaned, phosphatized, primed, and finished with a grey, baked enamel. The maximum temperature of the top of the enclosures should not exceed about a 50° C. rise above about a 40° C. ambient temperature. The transformers' sound level should not exceed 50 dB at a distance of about three (3) feet. Transformer magnetizing inrush current should be limited to nine (9) times the transformer rated primary current.

All terminals and lugs should be made of copper. Use of aluminum is not advised. All field wiring should terminate on a terminal strip.

An example of the dimensions of the step-up transformer 420 may be thirty-one (31) inches in width, twenty (20) inches in depth, and thirty-six (36) inches in height. To meet regulatory clearances (such as those by the NEC), the step-up transformer 420 must have at least forty-two (42) inches clearance in the front and at least six (6) inches at the sides and in the rear for air circulation. It may be placed at an 80-degree rise. Where there are two or more transformers, they should not be stacked on top of each other.

As an added preventive measure, there may be a phase monitor module 320. This module 320 serves to protect the traction elevator from phase loss, phase reversals, and phase imbalances that may be caused by one or more blown fuses, broken wires, or worn contacts. It may also help prevent the traction elevator motor from running at temperatures outside its approved temperature rating. Collected information, such as phase status and warmings, may be communicated to the Controller 140.

B. Additional Features

1. Leveling System

The traction elevator may incorporate a leveling system to perform all functions incidental to the control system that relate to the position and movement of the traction elevator in the hoistway. The traction elevator may be equipped with a self-leveling device that automatically levels elevator cars within a tolerance of 1/4 inch above or below the floor level of any floor for which a stop has been initiated, regardless of load or direction of travel. This self-leveling feature may be entirely automatic, independent of operating devices, and may correct for over travel and under travel. The leveling system may be of the magnetic tape type.

2. Fault Monitoring and Logging

Controller 140 may independently monitor all switches and devices. When one or multiple switches activate, Controller 140 may be able to identify which switches have been activated. If more than one switch performs the same function, each switch should be monitored independently.

Controller 140 should provide faults for all conditions that prevent the elevator from operating. Nonlimiting examples of faults include: Panel Emergency Stop Switch; Pit Stop Switch; Emergency Access Door contact open; Plank Switch; Final Limit Switches (top and bottom); Emergency Hatch; Safety Jumped; Safety String Check; Unintended Motion Emergency Brake Activated; Drive Failure; Door Locks Failure; Door Limits Failure; Gate Switches Failure; Gate Switches Bypass Failure; Safety Edge Failure; Fuses Failure; Relays Failure; Hoistway Limit Switches Failure; Brake Failure; Power Failure; In Car Panel Stop Switch; Auto/Inspection/Access Switches Failure; 60 kW UPS System Battery Failure; Fireman Services; Call Buttons Stuck; Governor Tension Cable Switch; Slack Cable Switch; 10 kVA UPS UPS System Battery Failure; Emergency Brake Release Door Open; Rail Block Switches; Governor Over Speed Switch; 60 kW UPS System Battery Low; and 10 kVA UPS System Battery Low. When one or more faults exist, Controller 140 may send an alarm signal and/or alert to its touch screen monitor.

3. Variable Voltage Variable Frequency (VVVF) Drive

The traction elevator may further include a VVVF drive specifically designed for use on elevators.

The VVVF drive may be designed so that traction elevator motor encoder 332 can be replaced without the need to remove the ropes from the AC-VVVF machine (such as a gearless one) or to put a load in the elevator car.

The VVVF drive may provide pre-torque to minimize re-leveling when passengers enter and exit the elevator.

Dual power drives may be provided. The normal power drive may be AC input/DC output and should be fully regenerative to the building line power source. The standby power drive may be DC input/DC output and should dissipate regenerative power via a resistor load bank.

4. Electromagnetic Capability

As an embodiment, because the claimed invention provides standby power when normal power is out, the claimed invention may enable the traction elevator to operate without the elevator having any degradation of performance, malfunctioning, unacceptable and undesirable response, or damage caused by radiated or conducted electromagnetic signals, noise, transients, or spikes.

As another embodiment, the claimed invention can operate a traction elevator without the traction elevator generating spurious electromagnetic signals, noise, transients, or spikes that can interfere with the operation of other equipment or affect personnel.

Electromagnetic capability may be considered in the basic design of the equipment to be furnished and installed. The application of electromagnetic control components including, but not limited to, filtering, shielding, bonding, and grounding, should conform to good engineering practice and, whenever possible, be an integral part of the equipment.

5. Continuous Operation Test Feature

The traction elevator may be provided with a continuous operation test feature that simulates continuous operation of the traction elevator by passengers when normal power is operating and when the claimed invention is operating due to normal power outage. Continuous use of the traction elevator may be simulated by making up and down trips while making stops at all landings. Car and hatch doors may open and close and all signal fixtures may operate. All devices may remain effective while in continuous operation mode. The door dwell time may be adjustable via the touch screen of the Controller 140. The touch screen may display the total time that has elapsed since continuous operation mode was initiated. The total number of trips made since continuous operation mode may be initiated and may also be displayed. Continuous operation mode may be able to be paused, without resetting the elapsed time and trip counter by use of the touch screen. While continuous operation mode may be paused, the traction elevator may be operated in any other mode before resuming continuous operation mode. The event and fault history log may continue to log events and faults during continuous operation mode.

Continuous operation test mode may be initiated via the touch screen of the Controller 140. It may only be activated when the Controller is in automatic mode. All other operation modes may take precedence over continuous operation mode.

6. Load weighing System

The traction elevator may include a dead-end hitch, rope or crosshead-mounted strain gages for weighing the passenger load when operating automatically under normal power. The control system may be designed to provide dispatching in advance of normal intervals. Settings may be individually adjusted from 50-80% of a full load.

When natural power is out, the claimed invention may allow for the load weighing system to be used to pre-torque machine motor to provide smooth acceleration from landing with a loaded car.

7. Traction Elevator Motor Horsepower

To determine the horsepower of the traction elevator, multiply the velocity of the elevator (in feet per minute (FPM) by the capacity of the traction elevator (in pounds) by the difference of the one minus the percentage of counterweight of elevator mass. Take this product and divide it by the product of 33,0000 by motor efficiency (as a percentage) by hoistway efficiency (also as a percentage; resulting from drive sheaves, deflector sheaves, and roller guides).

As an example, where the traction elevator is an Imperial Electric 908 elevator, the velocity may be 400 FPM, the capacity may be 10,000 pounds, the counterweight percentage may be 50%, the motor efficiency may be 90% and the hoistway efficiency may be 85%. Based on these numbers, the traction elevator motor horsepower may be calculated at 79.2, or rounded to 80.

C. Considerations

In this specification, “a” and “an” and similar phrases are to be interpreted as “at least one” and “one or more.”

Many of the elements described in the disclosed embodiments may be implemented as modules. A module is defined here as an isolatable element that performs a defined function and has a defined interface to other elements. The modules described in this disclosure may be implemented in hardware, software, firmware, wetware (i.e., hardware with a biological element) or a combination thereof, all of which are behaviorally equivalent. Modules implemented as a software may be written in a routine computer language (such as C, C++, Fortran, Java, Basic, Matlab or the like) or a modeling/simulation program (such as Simulink, Stateflow, or LabVIEW MathScript). Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above-mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) of using standby power to run a traction elevator when normal power is out. However, one skilled in the art will recognize that embodiments of the invention may be used on other types of elevators, such as hydraulic elevators and machine-room-less elevators.

In addition, any figures which highlight the functionality and advantages, are presented for example purposes only. The disclosed architecture is sufficiently flexible and configurable, such that it may be utilized in ways other than that shown. For example, the steps listed in a flowchart, if any, may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

1. An uninterruptable power supply (UPS) traction elevator lithium-ion (Li-ion) battery back-up system comprising:
a. a Primary Li-ion Battery Back-up System operating on standby power mode for a DC drive for a gearless traction elevator until such time the traction elevator experiences a natural power outage, at which time at least one Li-ion battery then supplies power to the gearless traction elevator motor; and
b. a Secondary Li-Ion Battery Back-up System supplying power to a Controller, gearless traction elevator components, other than the gearless traction elevator motor, and electrical circuits, when the natural power outage occurs.

2. The system according to claim 1, wherein the Primary Li-Ion Battery Back-up System comprises:
c. at least one Li-ion battery;
d. a lithium battery management system; and
e. a power interconnection module.

3. The system according to claim 2, wherein the at least one Li-ion battery is a rechargeable battery with at least 45 kW.

4. The system according to claim 3, wherein a battery charger supply recharges the at least one Li-ion battery through a UPS disconnect.

5. The system according to claim 2, wherein the power interconnection module is a terminal block for receiving power via electrical wires from one or more Li-ion batteries and powering the gearless traction elevator motor when natural power is out.

6. The system according to claim 1, wherein the Controller is programmed to trigger a signal when the at least one Li-ion battery of the Primary Li-Ion Battery Back-Up System is insufficiently charged.

7. The system according to claim 1, wherein the Secondary Li-Ion Battery Back-up System comprises:
a. at least one Li-ion battery;
b. a lithium battery management system; and
c. a UPS.

8. The system according to claim 7, wherein the at least one Li-ion battery is a rechargeable battery with at least 45 kW.

9. The system according to claim 7, wherein the UPS is at least 10 kVA.

10. The system according to claim 1, comprising further a thermal management system.

11. An uninterruptable power supply (UPS) traction elevator lithium-ion (Li-ion) battery back-up system comprising:
a. a Primary Li-ion Battery Back-up System operating on standby power mode for a DC drive for a geared traction elevator until such time the traction elevator experiences a natural power outage, at which time at least one Li-ion battery then supplies power to the geared traction elevator motor; and
b. a Secondary Li-Ion Battery Back-up System supplying power to a Controller, geared traction elevator components, other than the geared traction elevator motor, and electrical circuits, when the natural power outage occurs.

12. The system according to claim 11, wherein the Primary Li-Ion Battery Back-up System comprises:
a. at least one Li-ion battery;
b. a lithium battery management system; and
c. a power interconnection module.

13. The system according to claim 12, wherein the at least one Li-ion battery is a rechargeable battery with at least 45 kW.

14. The system according to claim 13, wherein a battery charger supply recharges the at least one Li-ion battery through a UPS disconnect.

15. The system according to claim 12, wherein the power interconnection module is a terminal block for receiving power via electrical wires from one or more Li-ion batteries and powering the geared traction elevator motor when natural power is out.

16. The system according to claim 11, wherein the Controller is programmed to trigger a signal when the at least one Li-ion battery of the Primary Li-Ion Battery Back-Up System is insufficiently charged.

17. The system according to claim 11, wherein the Secondary Li-Ion Battery Back-up System comprises:
a. A UPS;
b. at least one Li-ion battery; and
c. a lithium battery management system.

18. The system according to claim 17, wherein the UPS is at least 10 kVA.

19. The system according to claim 17, wherein the at least one Li-ion battery is a rechargeable battery with at least 45 kW.

20. The system according to claim 11, comprising further a thermal management system.
